(19) United States
(12) Patent Application Publication
(10) Pub. No.: US 2010/0146519 A1
(43) Pub. Date: Jun. 10, 2010

(54) SCA SYSTEM AND METHOD FOR OPERATION WAVEFORM APPLICATION THEREOF

(75) Inventors: Hwansouk Yoo, Daejeon-City (KR); Namhoon Park, Daejeon-City (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-City (KR)

(21) Appl. No.: 12/631,250

(22) Filed: Dec. 4, 2009

(30) Foreign Application Priority Data
Dec. 5, 2008 (KR) 10-2008-0123485
Nov. 13, 2009 (KR) 10-2009-0109612

(51) Int. Cl. G06F 9/54

(52) U.S. Cl. 719/313

(57) ABSTRACT

Disclosed is an SCA system. The SCA system includes: a domain profile in which mutual dependency information defined between a plurality of components of a waveform application is stored; and an assembly controller that simultaneously operates at least one component without dependency among a plurality of components according to the mutual dependency information stored in the domain profile.

### RELATED APPLICATIONS

The present application claims priority to Korean Patent Application Serial Number 10-2008-0123485, filed on Dec. 5, 2008 and Korean Patent Application Serial Number 10-2009-0109612, filed on Nov. 13, 2009, the entirety of which are hereby incorporated by reference.

### BACKGROUND OF THE INVENTION

1. Field of the Invention

The embodiment relates to an SCA system, and more specifically, to an SCA system that can reduce a command operation time and a method for operating a waveform application thereof.

2. Description of the Related Art

A Software Communication Architecture (hereinafter, referred to as an SCA) is a standardized communication software structure to largely improve interoperability between communication systems and to reduce development and distribution costs, which was proposed by Joint Tactical Radio System (JTRS) Joint Program Office (JPO), USA.

The SCA adopts COBRA (Common Object Request Architecture), which is an industrial standard of a real time operating system (RTOS) and a distributed object model, as middleware to provide an integrated environment of different kinds of hardware and software. Herein, the SCA is an independent system design framework rather than a standard limited to a specific system.

The basic architecture of the SCA is largely configured to include the real time operating system (RTOS), the CORBA middleware, a core framework (CF), and an application and the application in the SCA, which operates a function of one waveform, binds a plurality of components into one package and is operated by installing or disposing it.

A general protocol for communication is configured of a layer in an OSI 7 layer form and is configured of several layers from a physical layer that is a lowermost layer, to an application layer that is an uppermost layer. Each layer is configured as a service user (upper layer) and a service provider (lower layer) therebetween. At this time, the lower layer, which is the service provider, does not provide services even when the upper layer, which is the service user, starts even though the lower layer does not start, thereby causing the error situation.

In order to prevent the occurrence of errors, a method for preventing the occurrence of errors beforehand by sequentially operating the start from the lower layer to the upper layer has been developed. To this end, a system defines information on the start sequence of each component and controls the start sequence of each component using the information.

However, since a control method in the related art sequentially performs the start operation by the start sequence information that defines each component in the waveform application, there is a problem in that a time consumed to operate the start function of the entire waveform application is increased.

### SUMMARY OF THE INVENTION

The technical problem of the present invention provides an SCA system that can shorten an operation time of a waveform application.

Another technical problem of the present invention provides a method for operating a waveform application using an SCA system.

In order to solve the technical problem, an SCA system according to one embodiment of the present invention includes: a domain profile in which mutual dependency information defined between a plurality of components of a waveform application is stored; and an assembly controller that simultaneously operates at least one component without dependency among a plurality of components according to the mutual dependency information stored in the domain profile.

In order to solve the technical problem, a method for operating a waveform application of an SCA system according to one embodiment of the present invention includes: storing mutual dependency information between a plurality of components in a domain profile; and simultaneously operating at least one component without dependency among a plurality of components according to the mutual dependency information.

In order to solve the technical problem, a method for operating a waveform application of an SCA system according to still another embodiment of the present invention includes: storing operating sequence information and mutual dependency information for each of a plurality of components in a domain profile; sequentially operating each of a plurality of components according to the operating sequence information but when the first component among the plurality of components is operated, simultaneously operating at least one component without dependency on a first component among the plurality of components; and after simultaneously operating the first component and at least one component without dependency, operating the components with dependency on the first component according to the mutual dependency information.

The SCA system and the method for operating a waveform application thereof according to the present invention sequentially operate the plurality of components included in the waveform application according to a command input from the outside but simultaneously operate at least one component without dependency, thereby making it possible to reduce the command operating time of the entire waveform application and thus improve the speed of the SCA system.

### BRIEF DESCRIPTION OF THE DRAWINGS

In order to more fully understand the drawings referenced in the detailed description of the present invention, each drawing will be briefly described:

FIG. 1 is a diagram showing a structure of an SCA system according to an embodiment of the present invention;

FIG. 2 is a diagram showing one example of driving the waveform application of the SCA system shown in FIG. 1;

FIG. 3 is an operating flow chart of the waveform application according to the embodiment of the present invention; and

FIG. 4 is a diagram showing one example of a domain profile for operating the waveform application of FIG. 3.

### DETAILED DESCRIPTION OF THE PREFERRED EMBODIMENTS

In order to fully understand the present invention, benefits in the operation of the present invention, and objects to be achieved by the embodiment of the present invention, the accompanying drawings illustrating the embodiment of the present invention and the contents described in the accompanying drawings should be referred thereto.

Hereinafter, exemplary embodiments of the present invention will be described in detail with reference to the accompanying drawings. Like reference number indicates like components throughout the drawings.

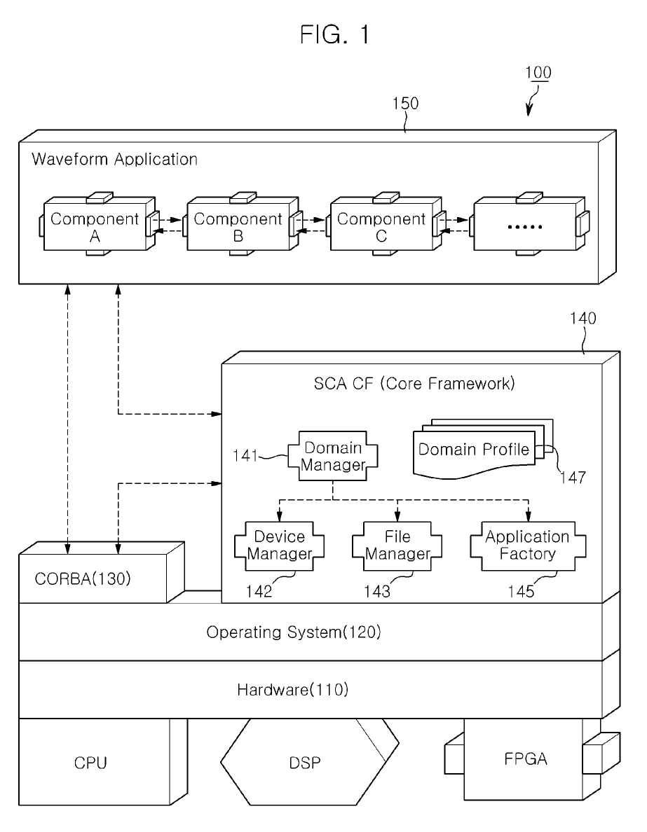

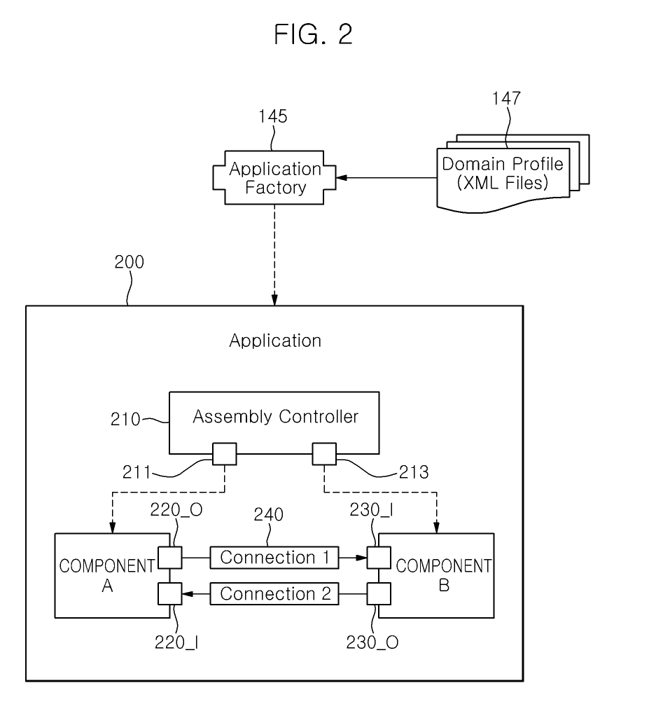

FIG. 1 is a diagram showing an SCA system according to the embodiment of the present invention and FIG. 2 is a diagram showing one example of operating a waveform application of the SCA system shown in FIG. 1.

Referring to FIG. 1, an SCA system 100 according to the present embodiment may include hardware 110, an operating system (OS) 120, a COBRA 130, an SCA core framework 140, and a waveform application 150.

The hardware 110 may include a central processing unit (CPU), a digital signal processor (DSP), a field programmable gate array (FPGA), etc.

The operating system 120, which is disposed on the hardware 110, may be a real time operating system and the COBRA 130, which is disposed on the operating system 120, may be middleware that is defined in the SCA.

The SCA core framework 140 may includes a domain manager 141, a domain profile 147, a device manager 142, a file manager 143, and an application factory 145.

According to the embodiment, the SCA core framework 140 may further includes a parser manager (not shown) that may parse information defined and stored in the domain profile 147.

The domain profile 147 of the SCA core framework 140 may store at least one information on each of a plurality of components included in the waveform application 150.

For example, the domain profile 147 may store information on a hardware and software component interface, logical location, operating sequence, mutual dependency, parameters related thereto, etc., on each of the plurality of components.

A plurality of managers of the SCA core framework 140, for example, the domain manager 141, the device manager 142, the file manager 143, or the application factory 145 may dispose the plurality of components of the waveform application 150 in the corresponding hardware and may operate them, based on the information stored in the domain profile 147.

Referring to FIGS. 1 and 2, the application factory 145 of the SCA core frame 140 may parse the plurality of information stored in the domain profile 147 to generate an application 200.

The application 200 may include an assembly controller 210 and may control the plurality of components, for example, component A and component B by the assembly controller 210.

For example, the application factory 145 may parse at least one of a variety of information stored in the domain profile 147 and thus generate the application 200.

The assembly controller 210 may receive at least one information parsed from the application 200 and store it. The assembly controller 210 may control the component A and the component B according to the stored information. The assembly controller 210 may output control information for controlling the component A and the component B through control ports 211 and 213.

Meanwhile, connection information 240 for communicating with an opponent component may be defined between the component A and the component B. For example, if the component A transfers any information to the component B, the component A may transfer information using an A output port 220_O that is defined in the connection information 240 and the component B may receive information through a B input port 230_I that is defined to connect to the A output port 220_O. The information transfer from the component B to the component A may also use the same method.

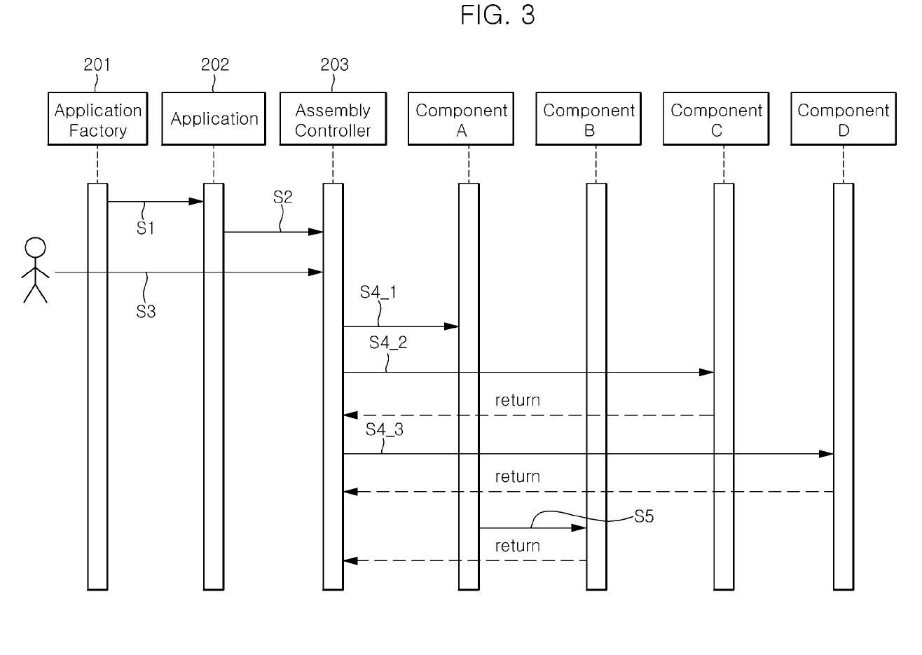

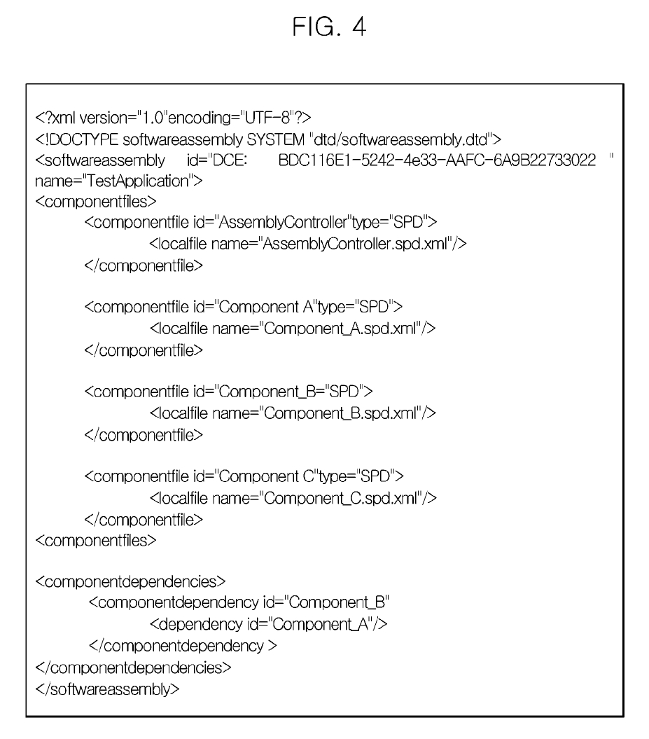

FIG. 3 is a flow chart of the operation of the waveform application according to the embodiment of the present invention and FIG. 4 is a diagram showing one example of the domain profile for operating the waveform application of FIG. 3. The present embodiment described, by way of example, four components included in the waveform application, but the present invention is not limited thereto.

Referring to FIGS. 1 to 3, when the SCA system 100 is initially driven, the application factory 145 may generate the application 200. The application factory 145 parses at least one of a variety of information stored in the domain profile 147 and transfers the parsed information to the application 200 (S1).

Herein, at least one information of the domain profile 147 parsed by the application factory 145 may be the mutual dependency information or the operating sequence information of each of the plurality of components of the waveform application 150.

For example, the waveform application 150 of the present embodiment may include four components, for example, component A, component B, component C, and component D.

In addition, the operating sequence information that is sequentially operated from component A to component D among the four components of the waveform application 150 and the mutual dependency information that the component B depends on the component A may each be defined and stored in the domain profile 147.

The application factory 145 parses the information stored in the domain profile 147 and transfers it to the application 200 and the application 200 may transfer the parsed information to the assembly controller 210 included therein and store it (S2).

Meanwhile, the mutual dependency information on each of the plurality components stored in the domain profile 147 may be an XML structure as shown in FIG. 4.

Referring to FIG. 4, the mutual dependency information stored in the domain profile 147 may be defined by <component dependencies> and <component dependency>. In other words, it is shown and defined in FIG. 4 that the component B depends on the component A, which may mean that the component B should be operated after the component A is operated.

Referring again to FIGS. 1 to 3, when the operating command is input from a user, the application 200 generated by the application factory 145 is called and the assembly controller 210 may be operated by the application 200. In the present embodiment, the case where the operating command input from the user is a start instruction of the plurality of components will be described as an example.

The assembly controller 210 can control the plurality of components, that is, four components according to the parsed information transferred from the application 200.

For example, the assembly controller 210 may start the component A among the plurality of components according to the operating sequence information of each of the plurality of components among the information parsed from the domain profile 147 by the application factory 145 (S4_1).

At this time, the assembly controller 210 may simultaneously start the remaining components, for example, the component C and the component D without dependency on the component A according to the mutual dependency information for each of the plurality of components parsed from the domain profile 147 by the application factory 145 (S4_2 and S4_3).

As described with reference to FIG. 4, the component A, component C, and component D among the plurality of components does not depend on each other and the component B depends on the mutual dependency information of the domain profile 147 that is defined as having dependency on the component A.

After the component A, the component C, and the component D are controlled to simultaneously start by the assembly controller 210, the assembly controller 210 may start the component B (S5). At this time, the assembly controller 210 may control the component B to start after the component A is operated.

In other words, the present invention may previously define the mutual dependency information in the domain profile 147, parse it, and control it in the assembly controller 210.

Then, when the start command is input from the user, the assembly controller 210 simultaneously starts the components without mutual dependency according to the mutual dependency information that is parsed and stored, thereby making it possible to reduce the start command operation time of the entire waveform application 150.

For example, as shown in FIG. 3, the waveform application 150 including four components simultaneously operates the components A, C, and D by the assembly controller 210, such that it can reduce the start command operating time of the entire waveform application 150 as compared to the related art.

In addition, although the above-mentioned embodiments describe the start operation of the plurality of components, this is only one of the various embodiments of the present invention. The present invention may also be used for a stop command of the plurality of components or a device load/unload command operation by the device manager.

Although the exemplary embodiments have been described and illustrated in the drawings and the description, this is described by way of example. Therefore, it will be appreciated to those skilled in the art that various modifications are made and other equivalent embodiments are available. Accordingly, the actual technical protection scope of the present invention must be determined by the spirit of the appended claims.

What is claimed is:

1. An SCA system comprising:
a domain profile in which mutual dependency information defined between a plurality of components of a waveform application is stored; and
an assembly controller that simultaneously operates at least one component without dependency among a plurality of components according to the mutual dependency information stored in the domain profile.

2. The SCA system according to claim 1, wherein
the domain profile further stores operating sequence information of each of the plurality of components, and
the assembly controller sequentially operates each of the plurality of components according to the operating sequence information but when a first component among the plurality of components is operated, simultaneously operates at least one component without dependency on the first component among the plurality of components.

3. The SCA system according to claim 2, wherein the assembly controller simultaneously operates the first component and at least one component without dependency and then, operates the components with dependency on the first component according to the mutual dependency information.

4. The SCA system according to claim 1, wherein the mutual dependency information is defined as an XML format, which is stored in the domain profile.

5. The SCA system according to claim 1, wherein the SCA system further includes an application factory that parses the mutual dependency information stored in the domain profile to generate an application.

6. The SCA system according to claim 5, wherein the application further includes an assembly controller that controls the plurality of components according to the parsed mutual dependency information.

7. A method for operating a waveform application of an SCA system, comprising:
storing mutual dependency information between a plurality of components in a domain profile; and
simultaneously operating at least one component without dependency among a plurality of components according to the mutual dependency information.

8. The method for operating a waveform application of an SCA system according to claim 7, further includes
storing operating sequence information of each of the plurality of components in the domain profile, and
wherein, the simultaneously operating at least one component without dependency among the plurality of components sequentially operates each of the plurality of components according to the operating sequence information but when a first component among the plurality of components is operated, simultaneously operates at least one component without dependency on the first component among the plurality of components.

9. The method for operating a waveform application of an SCA system according to claim 8, wherein the simultaneously operating the components without dependency among the plurality of components simultaneously operates the first component and at least one component without dependency and then, operates the components with dependency on the first component according to the mutual dependency information.

10. The method for operating a waveform application of an SCA system according to claim 8, wherein the operating sequence information of each of the plurality of components is defined as an XML format, which is stored in the domain profile.

11. The method for operating a waveform application of an SCA system according to claim 7, wherein the simultaneously operating at least one component without dependency among the plurality of components further includes:
parsing the mutual dependency information stored in the domain profile to generate an application; and
controlling the plurality of components according to the mutual dependency information parsed using an assembly controller of the application.

12. The method for operating a waveform application of an SCA system according to claim 7, wherein the mutual dependency information between the plurality of components is defined as an XML format, which is stored in the domain profile.

13. A method for operating a waveform application of an SCA system, comprising:
storing operating sequence information and mutual dependency information for each of a plurality of components in a domain profile;
sequentially operating each of a plurality of components according to the operating sequence information but when the first component among the plurality of components is operated, simultaneously operating at least one component without dependency on a first component among the plurality of components; and
after simultaneously operating the first component and at least one component without dependency, operating the components with dependency on the first component according to the mutual dependency information.

14. The method for operating a waveform application of an SCA system according to claim 13, wherein the simultaneously operating at least one component without dependency on the first component among the plurality of components further includes:
parsing the mutual dependency information stored in the domain profile to generate an application; and
controlling the plurality of components according to the mutual dependency information parsed using an assembly controller of the application.

15. The method for operating a waveform application of an SCA system according to claim 13, wherein each of the operating sequence information and the mutual dependency information for each of the plurality of components is defined as an XML format, which is stored in the domain profile.
